(19) United States
(12) Patent Application Publication
(10) Pub. No.: US 2011/0202728 A1
(43) Pub. Date: Aug. 18, 2011

(54) METHODS AND APPARATUS FOR MANAGING CACHE PERSISTENCE IN A STORAGE SYSTEM USING MULTIPLE VIRTUAL MACHINES

(75) Inventors: Charles E. Nichols, Wichita, KS (US); Mohamad H. El-Batal, Westminster, CO (US); Martin Jess, Erie, CO (US); Keith W. Holt, Wichita, KS (US); William G. Lomelino, Westminster, CO (US)

(73) Assignee: LSI CORPORATION, Milpitas, CA (US)

(21) Appl. No.: 12/706,838

(22) Filed: Feb. 17, 2010

(51) Int. Cl. G06F 12/00; G06F 9/455; G06F 12/08; G06F 12/16

(52) U.S. Cl. 711/141; 718/1; 711/162; 711/118; 711/E12.001; 711/E12.103; 711/E12.026

(57) ABSTRACT

Methods and systems for assuring persistence of battery backed cache memory in a storage system comprising multiple virtual machines. In one exemplary embodiment, an additional process is added to the storage controller that senses the loss of power and copies the entire content of the cache memory including portions used by each of the multiple virtual machines to a nonvolatile persistent storage that does not rely on the battery capacity of the storage system. In another exemplary embodiment, the additional process calls a plug-in procedure associated with each of the virtual machines to permit the virtual machine to assure that the content of its portion of the cache memory is consistent before the additional process copies the cache memory to nonvolatile memory. The additional process may be integrated with the hypervisor or may be operable as a separate process in yet another virtual machine.

### BACKGROUND

1. Field of the Invention

The invention relates generally to storage systems and more specifically relates to maintaining cache persistence in a storage controller of a storage system in which the storage controller comprises multiple virtual machines each using a cache memory.

2. Discussion of Related Art

Storage systems have evolved in directions in which the storage controller of the storage system provides not only lower-level storage management such as RAID (Redundant Array of Independent Drives) storage management but also provides a number of higher layer storage applications operating within the storage controller on the storage system. These storage applications are made available to host systems with access to the storage system. For example, some storage systems include applications to provide: continuous data protection through automated backup procedures, database management application processes, snapshot (e.g., “shadow copy”) management processes, the de-duplication management processes, etc.

Some commercial storage system products providing such storage management coupled with the storage applications utilize Virtual Machine Managers (commonly referred to as “hypervisors”) to provide a virtual machine for each of the multiple application processes as well as for the lower-level storage management processes. In general, a hypervisor controls the overall operation of each of a plurality of virtual machines. Each virtual machine may include its own specific operating system kernel and associated application processes such that the hypervisor hides the underlying physical hardware circuitry interfaces from the operating system and application processes operating within a virtual machine. A variety of such virtual machine operating systems are well known and commercially available including, for example, the Xen hypervisor and the VMWare hypervisor. Information regarding these and other virtual machine operating systems as well known to those of ordinary skill and generally available at, for example, www.xen.org and www.vmware.com.

In virtual storage system controllers it is common that the lower level storage management processes (e.g., RAID storage management processes) operates in a virtual machine under control of the hypervisor and that the various application processes each run in separate virtual machines. All the virtual machines typically utilized cache memory to enhance their respective performance. Thus, each virtual machine in such a virtual machine storage controller may include access to a shared cache memory.

Typically, the cache memory is implemented as a battery backed random access memory (RAM) so that loss of power to the storage system will not result in immediate loss of data in the cache memory. The battery power retains the content in the cache memory until external power is restored to the storage system. However, as the size of the cache memories for storage management and various storage applications increase, the load increases on such a battery used for retaining the volatile cache memory content. To assure that the content of the cache memory is maintained for a sufficient period of time to allow restoration of external power therefore requires ever-larger battery components. Larger battery systems impose added cost and complexity to the storage systems.

Thus, it is an ongoing challenge to assure that cache memory utilized by a plurality of virtual machines in a storage controller of a storage system is retained during a potentially lengthy loss of power to the storage system.

### SUMMARY

The present invention solves the above and other problems, thereby advancing the state of the useful arts, by providing methods and apparatus for managing persistence of the content of cache memory used by each of multiple virtual machines operating in a storage controller. In accordance with features and aspects hereof, a storage controller assigns each of multiple virtual machines a corresponding portion of a shared cache memory. Upon loss of external power to the storage system, a persistence apparatus of the storage controller (operating under battery power to the storage controller) copies the content of each portion of the cache memory to a persistent memory thus assuring persistence of the cache content before battery power is exhausted. Upon restoration of the external power to the storage system, the persistence apparatus may restore the content of each portion of the cache memory before allowing the virtual machine to resume operation.

A first aspect hereof provides a method operable in a storage controller of a storage system for maintaining cache persistence. The storage controller includes a persistent memory, a cache memory, and multiple virtual machines coupled with the cache memory and operating under control of a hypervisor. The method includes associating each of multiple portions of cache memory with a corresponding virtual machine of the multiple virtual machines and sensing a loss of external power to the storage controller. The method also includes copying content from each portion of the cache memory associated with a corresponding virtual machine to the persistent memory in response to sensing the loss of external power.

Another aspect hereof provides apparatus in a storage system. The apparatus includes a battery and a storage controller coupled to the battery to receive power temporarily in case of loss of external power to the storage controller. The storage controller includes multiple virtual machines under control of a hypervisor and a cache memory coupled with each of the multiple virtual machines. The cache memory has multiple portions, each portion associated with a corresponding virtual machine of the multiple virtual machines. The storage controller also has a persistent memory adapted to persistently retain stored information despite loss of external power and a persistence apparatus coupled with the cache memory, coupled with the persistent memory, coupled with the hypervisor, and coupled with the multiple virtual machines. The persistence apparatus is adapted to receive a power loss signal from the hypervisor indicating loss of external power. The persistence apparatus is further adapted to copy content from each of the multiple portions of the cache memory to the persistent memory in response to receipt of the power loss signal.

Yet another aspect hereof provides a computer readable medium embodying stored program instructions for performing various methods hereof.

### BRIEF DESCRIPTION OF THE DRAWINGS

FIG. 1 is a block diagram of an exemplary system including a storage system with multiple virtual machine, the system enhanced to ensure persistent saving of cache content in accordance with features and aspects hereof.

FIG. 2 is a block diagram of an exemplary embodiment of a persistence apparatus of FIG. 1 adapted to communicate with plug-in functions in each virtual machine in accordance with features and aspects hereof.

FIGS. 3 and 4 are block diagrams of exemplary embodiments for integrating the persistence apparatus of FIG. 1 into various virtual machine environments in accordance with features and aspects hereof.

FIGS. 5 through 7 are flowcharts describing exemplary methods for managing cache persistence of a storage controller having multiple virtual machines in accordance with features and aspects hereof.

FIG. 8 is a block diagram of an exemplary computing device adapted to receive a computer readable medium embodying methods for persistence management of cache memory in accordance with features and aspects hereof.

### DETAILED DESCRIPTION OF THE DRAWINGS

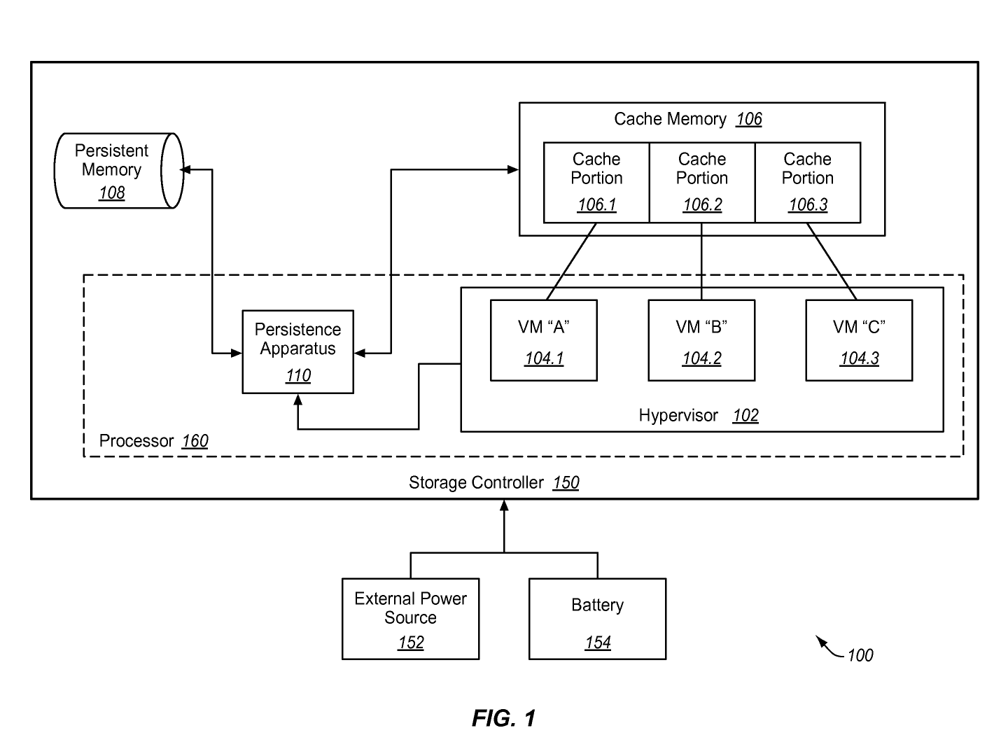

FIG. 1 is a block diagram of a storage system 100 enhanced in accordance with features and aspects hereof. System 100 includes storage controller 150 powered by either of two power sources—external power source 152 and battery power 154. If the external power source 152 fails, battery power 154 may substitute for the external power loss of external power for a relatively brief period of time. Storage controller 150 includes multiple virtual machines: virtual machine (VM) “A” 104.1, VM “B” 104.2, and VM “C” 104.3 all operable under control of hypervisor 102. As noted above, each of the virtual machines (104.1 through 104.3) may be adapted to provide storage related management and applications for use by one or more attached host systems (not shown).

Storage controller may include processor 160 on which hypervisor 102 and VMs 104.1 through 104.3 may operate. Processor 160 may be any suitable computing device and associated program and data memory for storing programmed instructions and associated data. Processor 160 may be any general or special purpose processor and associated programmed instructions and/or may include customized application specific integrated circuits designed specifically for virtual machine processing.

Storage controller 150 also includes cache memory 106 logically subdivided into portions each of which corresponds to one of the virtual machines. For example, cache portion 106.1 is utilized by virtual machine “A” 104.1, cache portion 106.22 is utilized by virtual machine “B” 104.2, and cache portion 106.3 is utilized by virtual machines “C” 104.3. Those of ordinary skill in the art will readily recognize that any number of virtual machines may be provided under control of hypervisor 102 and hence a corresponding number of portions of cache memory 106 may be defined. Further, the size of each cache portion 106.1 through 106.3 may be fixed and equal or may vary depending upon the needs of each particular virtual memory virtual machine.

Cache memory 106 is typically implemented utilizing volatile, non-persistent, random access memory (e.g., static or dynamic Random Access Memory—RAM). But for the presence of battery 154, loss of power from external power source 152 would cause total loss of the content of the volatile, non-persistent cache memory 106. Battery 154 is adapted to provide backup power in case of loss of power from external source 152 but only for a brief period of time. As noted above, the power load imposed on the battery 154 increases as the size of cache memory 106 continues to increase. In the context of storage controller 150 having multiple storage related processes each operating in a virtual machine with an associated portion of cache memory, the power load on battery 154 may be substantial. Thus, the time that battery 154 may power the storage controller 102 is limited.

Storage controller 150 also includes persistent memory 108 that does not rely on continuous application of power to retain its stored data. Persistent memory 108 may be implemented as any suitable nonvolatile, persistent memory device components including, for example, flash memory, and disk storage such as optical or magnetic disk storage.

Storage controller 150 also includes persistence apparatus 110 coupled with cache memory 106, with persistent memory 108, with the hypervisor 102 and each of the virtual machines 104.1 through 104.3. Persistence apparatus 110 is adapted to receive a power loss signal from the hypervisor indicating loss of external power 152 (and hence switchover of controller 150 to battery power 154). Persistence apparatus 110 is further adapted to copy the content from each of the multiple portions 106.1 through 106.3 of cache memory 106 to the persistent memory 108 responsive to the signal detecting loss of external power. Copying the content of cache 106 to persistent memory 108 prevents loss of data in cache memory 106.

Persistence apparatus 110 may be implemented as suitably programmed instructions executed by processor 160 or may be implemented as suitably designed custom integrated circuits dedicate to the functions performed by the apparatus 110. Further, in exemplary embodiments, persistence apparatus may be implemented as tightly integrated with the hypervisor or as distinct from the hypervisor (e.g., operable within a virtual machine managed by the hypervisor). Further details of exemplary embodiments of persistence apparatus 110 are presented herein below.

Those of ordinary skill in the art will readily recognize numerous additional and equivalent components and modules in a fully operational system 100. Such additional and equivalent components are omitted herein for simplicity and brevity of this discussion

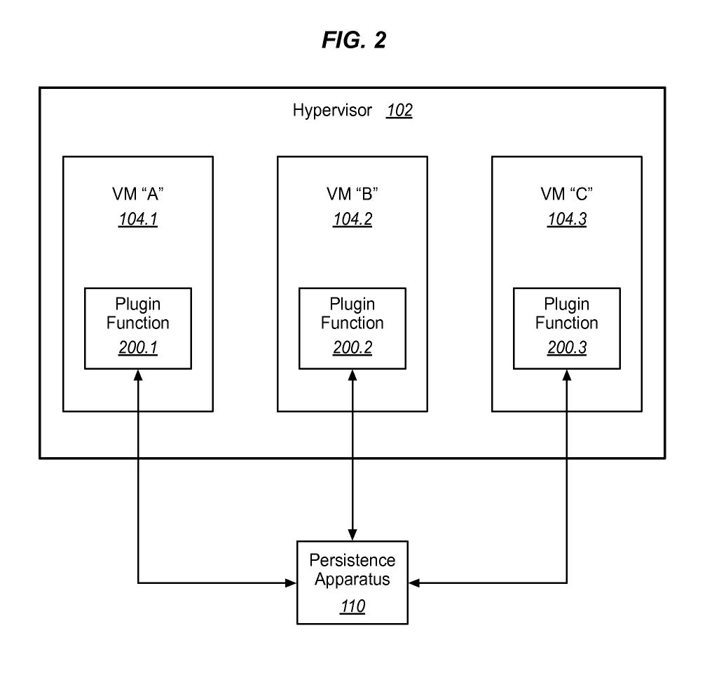

FIG. 2 is a block diagram describing exemplary additional details of the interaction between persistence apparatus 110 and virtual machines 104.1 through 104.3. In the exemplary embodiment of FIG. 2, each virtual machine 104.1 through 104.3 provides a corresponding plug-in function 200.1 through 200.3, respectively, for coupling with persistence apparatus 110. In some embodiments, virtual machines may utilize cache memory in such a manner that the cache memory may not always be in a consistent state. For example, if a virtual machine 104.1 through 104.3 stores certain information in its own memory space and only periodically flushes or posts such information to its portion of cache memory, the cache memory may be in an inconsistent state until flushing or posting by the virtual machine is completed. In such embodiments, loss of external power during a period of cache inconsistency may be problematic. In one exemplary embodiment, the virtual machine 104.1 through 104.3 and their respective plug-in functions 200.1 through 200.3 do not have direct access to persistent memory 108. Rather, only persistence apparatus 110 is permitted access to the persistent memory 108. Persistence apparatus 110 invokes the plug-in function 200.1 through 200.3 in each of the virtual machines 104.1 through 104.3, respectively, in response to detecting loss of external power. Each plug-in function 200.1 through 200.3 is responsible for assuring that the portion of cache memory used by its corresponding virtual machine is in a cache consistent state. In other words, plug-in function 200.1 through 200.3 is responsible for flushing, posting, and/or otherwise reorganizing or updating the content of its corresponding portion of cache memory. By first invoking the plug-in function 200.1 through 200.3 for each virtual machine 104.1 through 104.3, persistence apparatus 110 may ensure that the content of the cache memory assigned to each virtual machine is in a consistent state before persistence apparatus 110 saves it to persistent memory 108.

In other exemplary embodiments discussed further below, the plug-in function 200.1 through 200.3 may also return information to the persistence apparatus 110 when the plug-in function is invoked. The return information may indicate a subset of the portion of cache memory that is actually utilized by the corresponding virtual machine 104.1 through 104.3 (as opposed to merely allocated for the corresponding virtual machine). In such embodiments, the persistence apparatus 110 may save only the subset of the cache portion (106.1 through 106.3 of FIG. 1) indicated by the return values from the corresponding plug-in functions 200.1 through 200.3 of each virtual machine 104.1 through 104.3, respectively.

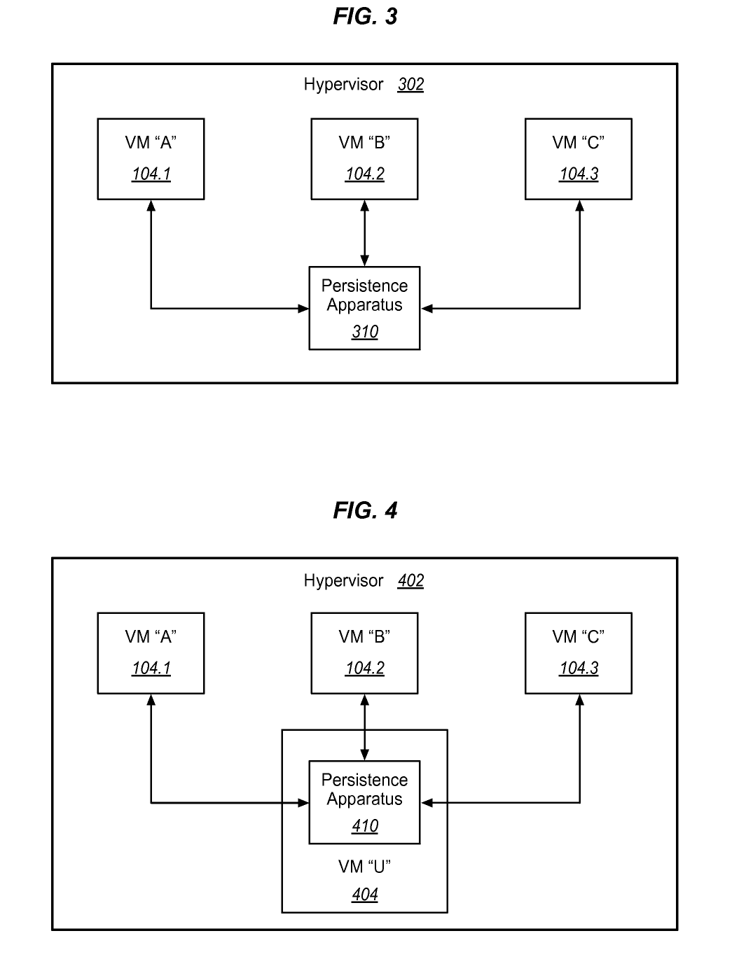

Persistence apparatus 110 as shown in FIGS. 1 and 2 may be implemented in a number of manners based on the requirements of the particular virtual machine hypervisor utilized in a particular environment. FIG. 3 is a block diagram showing one exemplary embodiment wherein persistence apparatus 310 is integrated as a component of hypervisor 302. Depending on the requirements of a specific virtual machine architecture, persistence apparatus 310 may be integrated with hypervisor 302 as a driver module and/or as a plug-in module within a virtual machine manager portion of the hypervisor. In particular, in the Xen virtual machine architecture, persistence apparatus 310 may be implemented as a component within “Xen domain 0” utilized for management and monitoring of virtual machines. In like manner in a VMWare virtual machine architecture, persistence apparatus 310 may be integrated within the kernel portions as a plug-in module in the VM manager. These and other embodiments for integrating persistence apparatus 310 within the hypervisor 302 of particular virtual machine architectures will be readily apparent to those of ordinary skill in the art. With persistence apparatus 310 so integrated within hypervisor 302, each of the virtual machines 104.1 through 104.3 may interact with persistence apparatus 310 as though it is a module integrated within the hypervisor 302 kernel software.

FIG. 4 is a block diagram describing and other exemplary embodiment for implementation of persistence apparatus in a virtual machine architecture. Persistence apparatus 410 of FIG. 4 is integrated within a special virtual machine (VM “U” 404). Many virtual machines architectures generally allow for some communications between the various virtual machines operating in the architecture. Such “cross domain” virtual machine communications, though generally available in many virtual machine architectures, typically has some limitations. In the Xen architecture for virtual machine management, one virtual machine is provided with supervisory or management capabilities with respect to other virtual machines. Thus the special virtual machine VM “U” 404 of FIG. 4 operates under hypervisor 402 with special privileges that allow persistence apparatus 410 to communicate (cross domain) with the other virtual machines 104.1 through 104.3.

The exemplary embodiments of FIGS. 3 and 4 and other design choices for implementing persistence apparatus 110, 310, and 410 in corresponding hypervisor architectures 102, 302, and 402, respectively are well known to those of ordinary skill in the art.

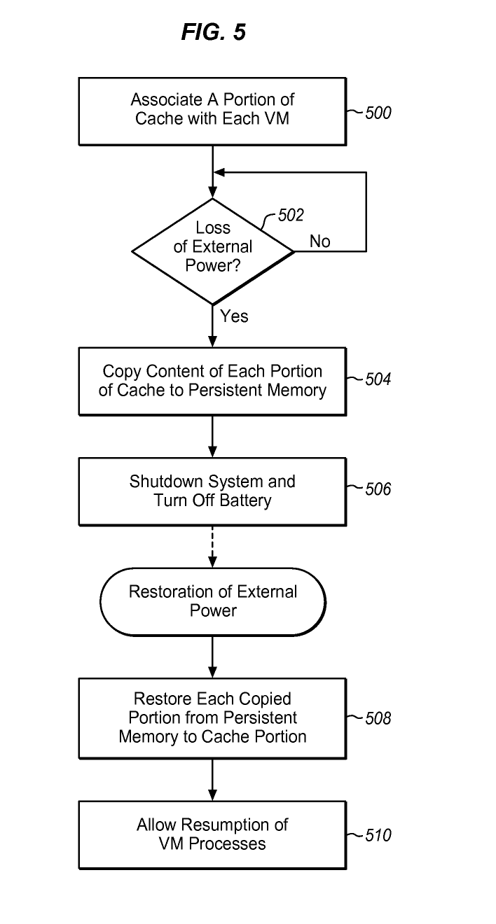

FIG. 5 is a flowchart describing an exemplary method in accordance with features and aspects hereof to assure cache memory persistence through loss of external power to a storage controller's storage system. The method of FIG. 5 may be operable, for example, in a system such as system 100 of FIG. 1 and more specifically in a storage controller such as a storage controller 150 of FIG. 1 including any of the virtual machine architectures described above with respect to FIGS. 2 through 4.

Step 500 associates a portion of a cache memory with each of the multiple virtual machines. As noted generally above, the size of each portion associated with each virtual machine either may be fixed and equal to all other portions or may vary depending upon the requirements of the particular virtual machine and application. Such design choices are readily apparent to those of ordinary skill in the art based on the needs of a particular storage application environment. Step 502 awaits detection of a signal indicating loss of external power to the storage controller. Upon sensing loss of external power to the storage controller, step 504 copies the contents from each portion of the cache memory associated with a corresponding virtual machine to the persistent memory. As noted above, though the cache memory is volatile and not persistent it retains its content after loss of external power for brief periods time based on battery power. By contrast, the persistent memory does not require any power source to retain its stored data.

Step 506 then shuts down the storage system and turns off the battery power. By shutting down the storage system completely and turning off the battery power source, the remaining charge in the battery may be conserved for subsequent uses after restoration of the external power. Later, external power to the storage controller may be restored (i.e., after the cause of failure for the external power is determined and remedied). Following restoration of the external power, step 508 restores each portion of the cache memory from a corresponding location in the persistent memory copy generated in step 506. Step 510 then allows resumption of virtual machine processing with the cache content fully restored to its state prior to loss of external power.

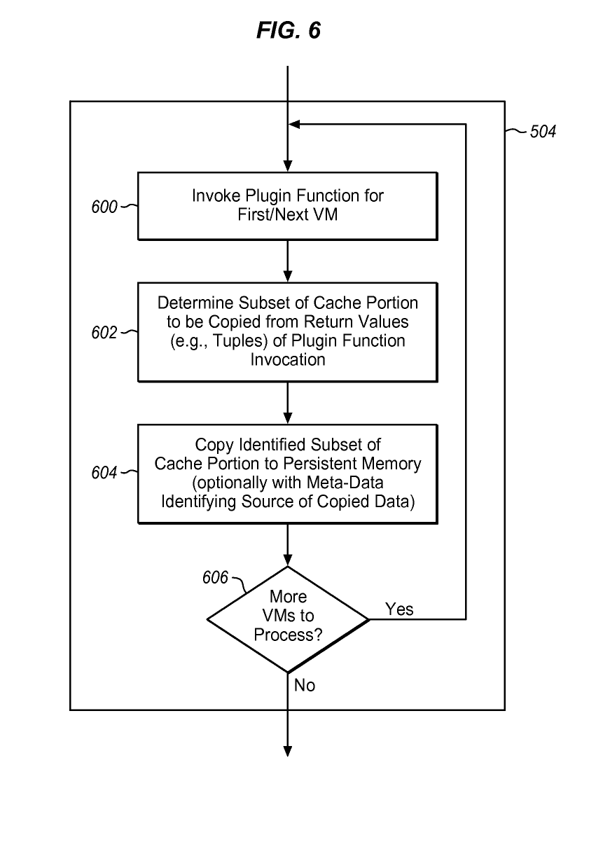

FIG. 6 is a flowchart providing exemplary additional details of the processing of step 504 of FIG. 5 to copy the contents of each portion of the cache memory to the persistent memory. As noted above, in one exemplary embodiment, each virtual machine may provide a plug-in function used for multiple purposes in association with the persistence apparatus features and aspects hereof. For example, the plug-in function may allow the virtual machine to assure that its portion of cache memory is in a consistent state such that the persistent copy to be made will be useful upon restoration. Further, for example, a return value from the invocation of the plug-in function by the persistence apparatus may define a subset of the cache portion associated with a virtual machine that requires copying to the persistent storage memory. It will be readily recognized by those of ordinary skill in the art that although a portion of cache memory has been assigned to a particular virtual machine, the virtual machine application processes may not require use of the entire assigned portion. Thus, the returned values provided from the invocation of the plug-in function inform the persistence apparatus of the subset of the portion of cache memory to be copied.

Step 600 invokes the plug-in function for the first or next virtual machine to be processed by the persistence apparatus responsive to sensing loss of external power. Step 602 determines from the returned values of the invocation of the plug-in function a subset of the cache portion of the current virtual machine that needs to be copied to the persistent storage. In one exemplary embodiment, the returned values provide a start address value and an extent value defining the location and length of a contiguous sequence of memory locations in cache memory to be copied to the persistent memory. In another exemplary embodiment, the returned values from the plug-in function invocation may represent one or more tuples of values wherein each tuple provides a start address value and an extent value for contiguous memory locations to be copied to the persistent memory. Where multiple such tuples are provided, the collection of memory locations defined by all such tuples comprises the subset of the cache portion that is to be copied to the persistent storage.

Having so determined the subset of cache portion to be copied, step 604 copies the identified subset of the cache portion for the present virtual machine to the persistent memory. Optionally, step 604 may also store meta-data that aids in identifying the exact locations in the portion of cache memory from which the copied subset is obtained. The meta-data may then be used later when restoring the copied portions of cache memory. Step 606 then determines whether more virtual machines remain to be processed for purposes of copying their respective portions of cache memory. If so, processing continues looping back iteratively repeating steps 600 through 606 until all virtual machines have been processed by the persistence apparatus.

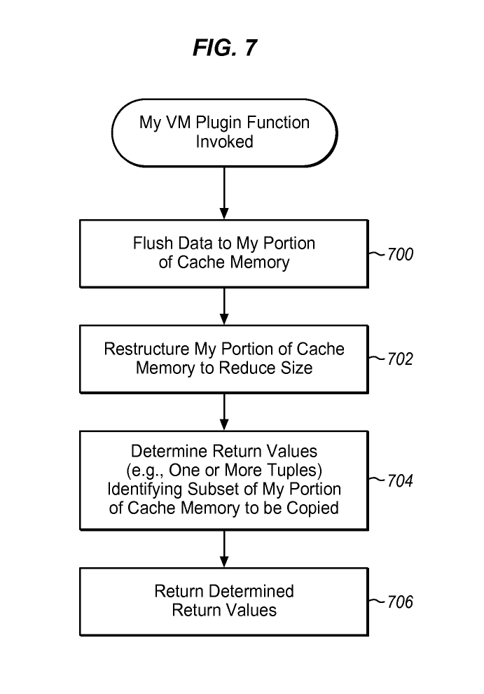

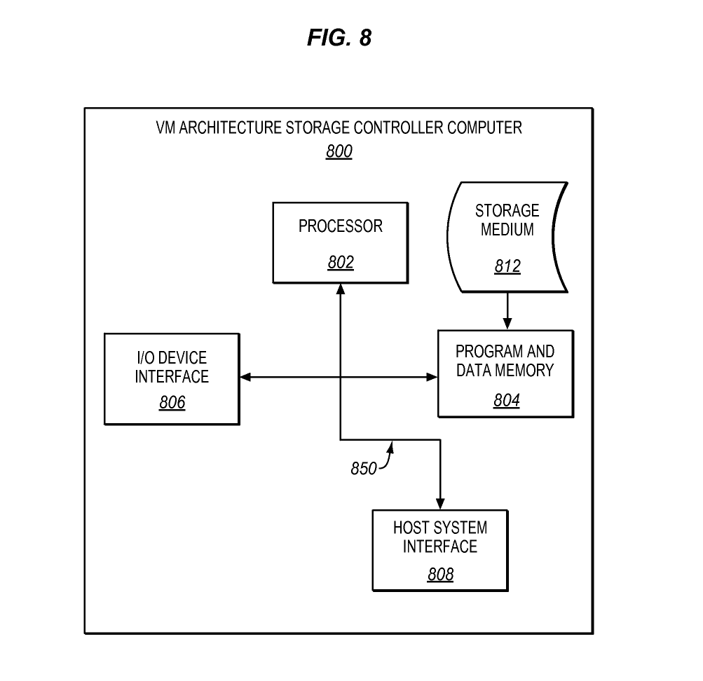

FIG. 7 is a flowchart describing an exemplary method operable within the each virtual machine of the virtualized storage controller. In particular, the exemplary method of FIG. 7 is performed by the plug-in function optionally provided within each virtual machine. The plug-in function may be invoked by the persistence apparatus as discussed above. Step 700 flushes or posts all data presently resident in the portion of cache memory assigned to the virtual machine whose plug-in function has been invoked (i.e., “my” portion being the portion assigned to the virtual machine executing the plug-in method of FIG. 7). Step 702 then restructures the portion of cache assigned to the present virtual machine. The restructuring may, for example, compact the content of the cache portion or, for example, may re-organize the content of the cache portion into a contiguous block of memory locations. The restructuring may also add meta-data useful to the virtual machine to restore the cache content to a functioning structure after restoration of the cache content from the persistent memory responsive to restoration of power to the storage system.

Step 704 then determines values to be returned to the invoking persistence apparatus to indicate a subset of the cache portion actually used by the virtual machine. As noted above, the restructuring of step 702 may assure that the content of the cache portion is reorganized into one or more contiguous blocks of memory locations. Thus, step 704 may determine one or more sets of values (i.e., one or more tuples) to be returned to the invoking persistence apparatus. Each tuple may then indicate, for example, a starting address and an extent of a contiguous block of memory to be saved and later restored by the persistence apparatus. Step 706 then returns to the invoking persistence apparatus with the return values determined by step 704.

Embodiments of the invention can take the form of an entirely hardware (i.e., circuits) embodiment, an entirely software embodiment or an embodiment containing both hardware and software elements. In one embodiment, the invention is implemented in software, which includes but is not limited to firmware, resident software, microcode, etc. FIG. 8 is a block diagram depicting an I/O controller device computer 800 adapted to provide features and aspects hereof by executing programmed instructions and accessing data stored on a computer readable storage medium 812.

Furthermore, embodiments of the invention can take the form of a computer program product accessible from a computer-usable or computer-readable medium 812 providing program code for use by or in connection with a computer or any instruction execution system. For the purposes of this description, a computer-usable or computer readable medium can be any apparatus that can contain, store, communicate, propagate, or transport the program for use by or in connection with the computer, instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

An I/O controller device computer 800 suitable for storing and/or executing program code will include at least one processor 802 coupled directly or indirectly to memory elements 804 through a system bus 850. The memory elements 804 can include local memory employed during actual execution of the program code, bulk storage, and cache memories that provide temporary storage of at least some program code in order to reduce the number of times code must be retrieved from bulk storage during execution.

Input/output interface 806 couples the controller to I/O devices to be controlled (e.g., storage devices, etc.). Host system interface 808 may also couple the computer 800 to other data processing systems.

While the invention has been illustrated and described in the drawings and foregoing description, such illustration and description is to be considered as exemplary and not restrictive in character. One embodiment of the invention and minor variants thereof have been shown and described. In particular, features shown and described as exemplary software or firmware embodiments may be equivalently implemented as customized logic circuits and vice versa. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

What is claimed is:

1. A method operable in a storage controller of a storage system for maintaining cache persistence, the storage controller comprising a persistent memory, a cache memory, and multiple virtual machines coupled with the cache memory and operating under control of a hypervisor, the method comprising:
associating each of multiple portions of cache memory with a corresponding virtual machine of the multiple virtual machines;
sensing a loss of external power to the storage controller; and
copying content from each portion of the cache memory associated with a corresponding virtual machine to the persistent memory in response to sensing the loss of external power.

2. The method of claim 1 wherein the storage system comprises a battery coupled with the storage controller, the method further comprising:
shutting down the storage system wherein the step of shutting down comprises turning off the battery.

3. The method of claim 1
restoring, responsive to restoration of external power, for each of the multiple virtual machines, a portion of content from the persistent memory to a corresponding portion of the cache memory associated to said each of the multiple virtual machines; and
allowing resumption of operation of the multiple virtual machines in response to completion of the step of restoring.

4. The method of claim 1
wherein each virtual machine provides a plug-in function, and
wherein the method further comprises:
invoking the plug-in function in each of the multiple virtual machines prior to the step of copying, wherein each virtual machine, responsive to invocation of its plug-in function performs the step of assuring cache coherency of its portion of cache memory.

5. The method of claim 4
wherein the plug-in function provided by each virtual machine is adapted to return values defining a subset of its portion of cache memory that is to be copied, and
wherein the step of copying further comprises:
copying content from the subset of said each portion to the persistent memory.

6. The method of claim 5
wherein the return values from each plug-in comprise a starting address value and an extent value defining the subset as contiguous memory locations to be copied.

7. The method of claim 5
wherein the return values from each plug-in comprise one or more tuples, each tuple comprising a starting address value and an extent value defining contiguous memory locations in its portion of cache memory to be copied, and
wherein the step of copying further comprises:
copying content from the subset of said each portion to the persistent memory wherein the subset is defined by the multiple tuples.

8. The method of claim 5
wherein the step of copying further comprises:
storing meta-data in the persistent memory, wherein the meta-data identifies one or more locations in the cache memory from which the subset was copied

9. Apparatus in a storage system, the apparatus comprising:
a battery; and
a storage controller coupled to the battery to receive power temporarily in case of loss of external power to the storage controller, the storage controller comprising:
multiple virtual machines under control of a hypervisor;
a cache memory coupled with each of the multiple virtual machines, the cache memory having multiple portions, each portion associated with a corresponding virtual machine of the multiple virtual machines;
a persistent memory adapted to persistently retain stored information despite loss of external power; and
a persistence apparatus coupled with the cache memory, coupled with the persistent memory, coupled with the hypervisor, and coupled with the multiple virtual machines, the persistence apparatus adapted to receive a power loss signal from the hypervisor indicating loss of external power and adapted to copy content from each of the multiple portions of the cache memory to the persistent memory in response to receipt of the power loss signal.

10. The apparatus of claim 9
wherein the persistence apparatus is integrated with the hypervisor.

11. The apparatus of claim 9
wherein the persistence apparatus is operable within a virtual machine distinct from the multiple virtual machines.

12. The apparatus of claim 9
wherein each virtual machine of the multiple virtual machines comprises:
a plug-in function, the plug-in function adapted to assure that the portion of cache memory associated with said each virtual machine is in a cache consistent state,
wherein the persistence apparatus is further adapted to invoke the plug-in function of said each virtual machine prior to copying to persistent memory the portion of cache memory that is associated with said each virtual machine.

13. The apparatus of claim 12
wherein the plug-in function of each virtual machine is adapted to return values defining a subset of its portion of cache memory that is to be copied, and
wherein the persistence apparatus is adapted to copy content from the subset of said each portion to the persistent memory.

14. The apparatus of claim 13
wherein the return values from each plug-in comprise a starting address value and an extent value defining the subset as contiguous memory locations to be copied.

15. The apparatus of claim 13
wherein the return values from each plug-in comprise one or more tuples, each tuple comprising a starting address value and an extent value defining contiguous memory locations in its portion of cache memory to be copied, and
wherein the persistence apparatus is adapted to copy content from the subset of said each portion to the persistent memory wherein the subset is defined by the multiple tuples.

16. The apparatus of claim 13
wherein the step of copying further comprises:
storing meta-data in the persistent memory, wherein the meta-data identifies one or more locations in the cache memory from which the subset was copied

17. A computer readable medium embodying programmed instructions that, when executed by a computing device of a storage controller in a storage system, perform a method for maintaining cache persistence, the storage system comprising a storage controller and a battery coupled with the storage controller, the storage controller comprising a persistent memory, cache memory, and multiple virtual machines coupled with the cache memory and operating under control of a hypervisor, the method comprising:
associating each of multiple portions of cache memory with a corresponding virtual machine of the multiple virtual machines;
sensing a loss of external power to the storage controller;
copying content from each portion of the cache memory associated with a corresponding virtual machine to the persistent memory in response to sensing the loss of external power;
shutting down the storage system wherein the step of shutting down comprises turning off the battery;
restoring, responsive to restoration of external power, for each of the multiple virtual machines, a portion of content from the persistent memory to a corresponding portion of the cache memory associated to said each of the multiple virtual machines; and
allowing resumption of operation of the multiple virtual machines in response to completion of the step of restoring.

18. The medium of claim 17
wherein each virtual machine provides a plug-in function, and
wherein the method further comprises:
invoking the plug-in function in each of the multiple virtual machines prior to the step of copying, wherein each virtual machine, responsive to invocation of its plug-in function performs the step of assuring cache coherency of its portion of cache memory,
wherein the plug-in function provided by each virtual machine is adapted to return values defining a subset of its portion of cache memory that is to be copied, and
wherein the step of copying further comprises:
copying content from the subset of said each portion to the persistent memory.

19. The medium of claim 18
wherein the return values from each plug-in comprise a starting address value and an extent value defining the subset as contiguous memory locations to be copied.

20. The medium of claim 18
wherein the step of copying further comprises:
storing meta-data in the persistent memory, wherein the meta-data identifies one or more locations in the cache memory from which the subset was copied.
